(19) United States
(12) Patent Application Publication
(10) Pub. No.: US 2004/0051412 A1
(43) Pub. Date: Mar. 18, 2004

(54) Alternator

(75) Inventors: Patrick Vohlgemuth, La Rochefoucauld (FR); Philippe R. Manfe, Linars (FR); Francois C. Czajkowski, Linars (FR)

Correspondence Address: OLIFF & BERRIDGE, PLC, P.O. BOX 19928, ALEXANDRIA, VA, 22320, US

(73) Assignee: MOTEURS LEROY SOMER, ANGOULEME (FR)

(21) Appl. No.: 10/613,075

(22) Filed: Jul. 7, 2003

(30) Foreign Application Priority Data
Jul. 10, 2002 (FR) 02 08666
Jul. 10, 2002 (FR) 02 08667
Jul. 10, 2002 (FR) 02 08668
Jul. 10, 2002 (FR) 02 08671

(51) Int. Cl. H02K 9/00

(52) U.S. Cl. 310/89; 310/58

(57) ABSTRACT

The present invention relates to an electric rotary machine comprising:

a casing of elongate shape;

a rotor having a shaft capable of turning inside the casing about an axis of rotation; and

a fan rotated by the rotor;

wherein the casing includes at least one air inlet grid and at least one air outlet grid, both of which are made integrally with the casing.

The present invention relates to rotary electric machines and more particularly, but not exclusively to alternators for electricity generator units of power lying in the range, for example, a few kilowatts (kW) to a few tens of kilowatts, for example less than 30 kW.

### BACKGROUND OF THE INVENTION

Patent application EP-A2-1 081 828 describes an alternator having a rotor that drives a fan. The fan rotates in a housing defining two passages each in the form of a volute for delivering the air driven by the fan. Each passage offers a path of increasing section for the air heading towards the outlet. The above-mentioned housing is defined by a separate piece fitted to the cylindrical body of the casing. In general, the electrical performance of an alternator depends on the efficiency with which it is cooled and it is desirable for cooling efficiency to be as high as possible.

Alternators for electricity generator units are also known that comprise:

a casing of elongate shape;

a rotor having a shaft capable of turning inside the casing about an axis of rotation; and

a fan rotated by the rotor.

In those prior art alternators, the grids protecting the air inlet and outlet openings are constituted by independent pieces, which implies assembly operations need to be performed on the casing during manufacture of the alternator, thereby increasing its cost price.

In addition, that can make fixing certain alternators on the driving engine relatively awkward when access to fasteners takes place through the openings via which the cooling air leaves. The protective grids need to be removed in order to give access to the fasteners, and subsequently they need to be put back into place.

Alternators for electricity generator units are also known that comprise:

a casing of elongate shape;

a rotor having a shaft capable of turning inside the casing about an axis of rotation; and

at least one alternator fixing flange at one end.

It is relatively awkward to fix certain alternators of that type to the engine since access to the fasteners takes place through the openings via which the cooling air leaves.

### OBJECTS AND SUMMARY OF THE INVENTION

There therefore exists a need for an alternator of low manufacturing cost that nevertheless presents satisfactory electrical performance and reliability.

There also exists a need to facilitate the flow of air for cooling the machine.

There also exists a need to have an electric machine, in particular an alternator, in which installing or removing the brush carrier is facilitated.

The present invention seeks in particular to satisfy all or part of these requirements.

In a first of its aspects, the invention provides a rotary electric machine comprising:

a casing of elongate shape;

a rotor having a shaft capable of turning inside the casing about an axis of rotation; and

a fan rotated by the rotor;

wherein the casing includes at least one air inlet grid and at least one air outlet grid, both of which are made integrally with the casing.

This avoids the need to fit the protective grids of prior art alternators on the casing, thus reducing the amount of labor needed for manufacturing the alternator.

In an exemplary embodiment of the invention, the casing is made as a casting, in particular out of injected aluminum.

The casing may include a flange at a first longitudinal end, and an end wall at a second longitudinal end opposite from the first, which end wall is made integrally with the casing and is perforated to form a grid to allow cooling air to enter into the casing.

On its inside face, the end wall may include a portion in relief enabling a brush carrier to be fixed. Said portion in relief may comprise a slideway and the brush carrier may be configured to slide in said slideway while it is being installed in the casing. Such a configuration makes it easier to install the brush carrier and makes it possible to further reduce the time taken to manufacture the alternator. Removing the brush carrier during maintenance is also made easier.

In a particular embodiment, the casing may have two side grids made integrally with the casing and situated respectively on the left and right sides of the casing when the alternator is observed along the axis of rotation of the rotor.

The casing may have at least one volute-shaped passage opening out to a side grid, and in particular it may have two volute-shaped passages associated respectively with the two above-mentioned side grids.

These volute-shaped passages can be made during molding of the casing, thus avoiding subsequent assembly operations.

At least one side grid may comprise bars, each bar having a longitudinal axis that is preferably curvilinear with a concave portion facing towards the fan. Each bar may be oriented substantially parallel to the plane perpendicular to the axis of rotation of the rotor. The bars may thus be substantially parallel to a vertical plane when the axis of rotation of the rotor is horizontal.

In another aspect of the invention, each side grid has no bars extending substantially parallel to the axis of rotation of the rotor, thereby reducing head losses in the air passing through the grid and thus improving the efficiency of the fan and the effectiveness of the cooling.

In order to make the bars of the grid easier to make, they may be molded together with a web of material which connects them together on their radially inner side. This web, which may be relatively thin, serves to reinforce the mechanical strength of the bars while the material is cooling down after molding. On leaving the foundry, the web is subsequently removed during an operation of machining the inside surface of the casing. Advantageously, after the casing has been molded, the method of manufacturing the casing includes the step which consists in progressively eliminating the web extending between the bars by machining in a single pass. This avoids a second pass, which might damage the bars.

The inside of the casing may be machined with the stator already in place therein so as to make it easier to ensure that the machined surfaces are concentric.

The casing may include extensions for supporting a protective cover for an electric circuit, in particular an electric circuit for regulating the alternator and for making connections thereto, said extensions including air inlet openings. The casing may have at least one opening that opens out beneath the cover so as to allow air to be sucked in from beneath it while the alternator is in operation. The increase in the efficiency of the fan due in particular to the side grids having no bars parallel to the axis of rotation of the rotor and to the presence of the volute-shaped passages serves to obtain a relatively large flow of cooling air beneath the cover.

The casing may have axial splines that are not machined on which the stator rests. The fact that these splines are not machined makes it possible to further reduce the cost of manufacture by avoiding a specific machining operation.

The casing may comprise a cylindrical body and the flange may have passages for fasteners on axes that are situated radially outside the envelope of the cylindrical body. It is thus possible to have easy access to the fasteners that are used for fixing the alternator to an engine, for example, without it being necessary to remove protective grids.

In another of its aspects, the invention provides independently or in combination with the above, a rotary electric machine comprising:

a casing;

a rotor capable of rotating inside the casing about an axis of rotation;

a fan fixed on the rotor; and

at least one outlet grid for air driven by the fan;

the grid having no bars that extend substantially parallel to the axis of rotation of the rotor or having a number of such bars that is less than or equal to the number of bars extending substantially parallel to a plane perpendicular to the axis of rotation.

Unlike prior art machines having grids that are fitted to the casing, these grids having a large number of mutually perpendicular bars, in the invention at least one of the grids has no bars that are substantially parallel to the axis of rotation or has a relatively small number thereof.

As a result, the head loss to which air passing through the grid is subjected is smaller than it would be if the grid had a large number of bars extending substantially parallel to the axis of rotation of the rotor. The bars can thus be made of a cross-section that is larger for equivalent head loss, thus making them easier to cast integrally with the casing.

The grid preferably has no bars extending substantially parallel to the axis of rotation of the rotor.

The casing may have air outlet passages which offer a section to the air flow that increases on approaching the outlet. These passages may be volute-shaped, for example.

The air may leave radially.

The bars of the grid may be made integrally with the casing, as mentioned above.

The bars may present respective central portions having a curvilinear longitudinal axis that is concave towards the fan. These central portions may be connected to the casing via connection portions which co-operate with the central portion-to form a concave side facing outwards. The connection portions may be adjacent to an enlarged portion of the air outlet passage.

The bars of the grid may present a radially inner side that is machined.

The grid may comprise two bars.

At one end, the casing may have a transverse wall that is perforated to enable air to be sucked in, and the casing may comprise a cylindrical body provided with an opening that opens out beneath a protective cover, extensions on which the cover bears being also made on the casing, these extensions being provided with openings, air being sucked in during operation of the fan through the perforated end wall, via the openings in the extensions, and through the opening made in the cylindrical body of the casing, and delivered through two air outlet grids as defined above.

In another of its aspects, the invention also provides independently or in combination with the above, an assembly comprising an alternator and a connection member enabling the alternator to be fixed on an engine, the alternator having a casing with a cylindrical body and a flange, wherein the flange has passages for fasteners for fastening the alternator to the connection member, these passages having axes situated outside the envelope of the cylindrical body of the casing, the connection member having a first set of holes for fastening the connection member to the engine, and a second set of holes disposed in such a manner as to be superposable on the passages through the flange for fastening the alternator to the connection member.

By using such a connection member, fastening the alternator to the engine is facilitated and, for example, it is possible to avoid having to access fasteners through the outlet openings for cooling air leaving the alternator. There is no longer any need to provide removable protective grids, and the casing may have bars extending across the air outlet openings that are made integrally with the casing, e.g. as a casting.

The connection member may include nuts fixed on one face of a plate, said face being situated facing the engine, the nuts being suitable for receiving screws inserted through holes of the second set of holes.

The connection member may have a first plane annular portion in which the holes of the first set of holes are made and a second plane annular portion in which the holes of the second set of holes are made, the second annular portion being axially offset relative to the first annular portion.

The offset between the first and second annular portions may be greater than the thickness of the nuts.

The connection member may include reinforcing ribs.

The connection member may have projecting portions in the form of circular arcs for co-operating with the alternator casing in order to contribute to centering the connection member relative to the alternator.

The alternator flange may be made integrally with the casing.

In another of its aspects, the invention also provides, independently or in combination with the above, an electricity generator unit comprising an alternator and an engine, wherein the alternator is fixed to the engine via a connection member.

The connection member may be configured to be suitable initially for fixing on the engine, and subsequently for fixing the alternator on the connection member.

The connection member may have holes enabling it to be fixed on the engine and nuts for receiving screws for fastening the alternator to the connection member.

In another of its aspects, the invention also provides independently or in combination with the above, a connection member for fixing an alternator on an engine, the connection member comprising:

a plate provided with an opening enabling a rotor alternator shaft of the alternator to be coupled with the engine;

a first set of holes for fixing the plate on the engine; and

a second set of holes situated radially outside the first set for fixing the alternator, on the plate.

In another of its aspects, the invention also provides independently or in combination with the above, a rotary electric machine comprising a stator and a rotor suitable for rotating about an axis of rotation inside the stator, the rotor comprising a yoke having windings disposed thereon, together with winding-retaining spacers, at least one spacer when seen in section in a plane perpendicular to the axis of rotation defining a concave side that is open towards the stator.

The presence of such a concave side facilitates the passage of cooling air so that cooling of the machine is thereby improved.

In another of its aspects, the invention also provides, independently or in combination with the above, a rotary electric machine comprising:

a rotor suitable for rotating about an axis of rotation, the rotor comprising:

a magnetic yoke having slots for receiving windings; and

damper windings comprising electrical conductors passing along corresponding passages in the magnetic yoke;

wherein said passages, when the rotor is observed in a plane perpendicular to the axis of rotating, are disposed in a manner that is not symmetrical about any plane containing the axis of rotation.

By disposing the passages in this way, it is possible to improve harmonic attenuation and/or the flow of magnetic flux.

On going circumferentially around the axis of rotation of the rotor on one side of a midplane, the spacing between consecutive passages need not be constant. In particular, this spacing may vary, e.g. monotonically, increasing on going circumferentially in the direction of rotation of the rotor. This enables the operation of the machine to be improved, particularly when loaded.

In another aspect of the invention, at least one passage may present a cross-section that is not circular. In particular, at least one passage may present a cross-section that is oblong, having a major axis that is oriented substantially radially. This disposition can facilitate the passage of flux.

The invention also provides, independently or in combination with the above, a rotary electric machine comprising:

a casing;

a rotor capable of rotating inside the casing; and

a brush carrier having brushes configured to come into electrical contact with the rotor;

wherein the brush carrier is fixed on an inside face of a transverse wall of the casing that is made integrally therewith and that includes a slideway enabling the brush carrier to be fixed.

Such a configuration facilitates installation of the brush carrier and can reduce the time required to manufacture the machine.

The brush carrier is configured to be capable of sliding in the slideway while being installed in the casing. Removing the brush carrier during a maintenance operation is thus also made easier.

Where appropriate, the slideway may also make it possible to position the brush carrier radially relative to the shaft of the rotor.

The transverse wall may be situated at one longitudinal end of the casing, and it may be pierced by a plurality of air inlet openings, for example.

The casing may comprise a cylindrical body pierced by an opening, for example adjacent to the above-mentioned slideway, through which the brush carrier can be installed or removed.

This opening may also serve as an air inlet into the casing for cooling purposes.

The brush carrier may be held in place in the slideway by a fastener such as a screw, for example, inserted through an extension of the brush carrier and screwed into the casing. The above-mentioned extension may be configured so as to enable the radial position of the brush carrier to be adjusted to a small extent.

The brush carrier may include stiffening webs extending parallel to a plane containing the axis of rotation of the rotor.

The machine may constitute an alternator, in particular for an electricity generator unit.

The slideway may be oriented radially.

The machine need not necessarily include brushes and a brush carrier. If it has no brushes, the field windings may be connected to capacitors.

The various aspects of the invention defined above may advantageously be implemented within the same machine, in particular an alternator, however that is not necessarily so, and any one of the aspects may be implemented independently.

### BRIEF DESCRIPTION OF THE DRAWINGS

The invention can be better understood on reading the following description of a non-liming embodiment and on examining the accompanying drawings, in which:

FIG. 1 is a diagrammatic perspective view showing an example of an alternator casing made in accordance with the invention;

FIG. 2 is a fragmentary and diagrammatic axial section view of an alternator including the casing of FIG. 1;

FIG. 3 shows the casing of FIG. 1 in isolation, and in side view;

FIG. 4 is a diagrammatic and fragmentary plan view seen looking along arrow IV of FIG. 3;

FIG. 5 is a cutaway diagrammatic and fragmentary face view seen looking along arrow V in FIG. 4;

FIG. 6 is a diagrammatic and fragmentary face view seen looking along arrow VI of FIG. 4;

FIG. 7 shows a brush carrier in isolation, in section on a midplane;

FIG. 8 is a diagrammatic and fragmentary plan view seen looking along arrow VIII in FIG. 7;

FIGS. 9 to 11 are face views showing various examples of prior art rotor laminations;

FIG. 12 is a face view of a rotor lamination with spacers;

FIG. 13 is a perspective view showing a spacer in isolation;

FIGS. 14 and 15 are fragmentary and diagrammatic face views showing respective ends of the rotor with the short-circuit “rings”;

FIG. 16 is a face view of the connection piece shown in isolation; and

FIG. 17 is a section view on XVII-XVII of FIG. 16.

### MORE DETAILED DESCRIPTION

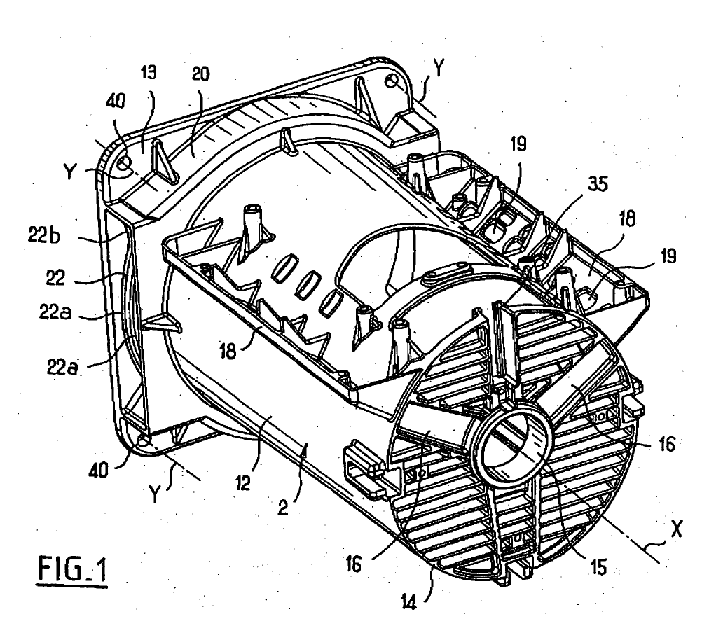

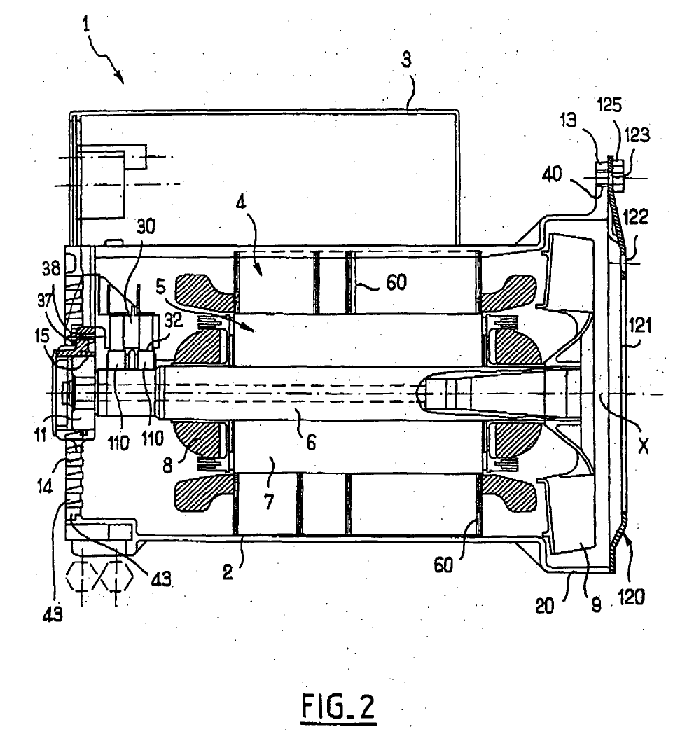

FIGS. 1 and 2 show an alternator 1 comprising a metal casing 2 and a cover 3 fitted on the casing 2. In the example described, the alternator 1 is designed to be fixed to an engine (not shown) in order to form an electricity generator unit. The cover 3 can be made of metal or of plastics material and serves, for example, to house a conventional electric circuit (not shown in the figures) for regulating and connecting the alternator.

As can be seen in FIG. 2, inside the cover 3, the alternator 1 comprises a stator 4 and a rotor 5 capable of rotating inside the stator 4 about an axis of rotation X.

The rotor 5 comprises a shaft 6 on which a magnetic yoke 7 is fixed that receives field windings 8.

The rotor 5 rotates a fan 9 for generating a flow of cooling air.

Casing

The casing 2 comprises a circularly cylindrical body 12 which is connected at a first longitudinal end via an enlarged portion 20 to a flange 13 for fixing the alternator on the engine via a connection member, as described in greater detail below.

The flange 13 has holes 40 of respective axes Y situated radially outside the envelope of the cylindrical body 12.

At a second longitudinal end opposite from the first, the casing 2 also comprises a perforated transverse wall 14 and a bearing 15 for supporting the rotor shaft.

Reinforcing ribs 16 extend radially between the bearing 15 and the cylindrical body 12.

The flange 13 and the bearing 15 are made integrally with the remainder of the casing, as an aluminum casting in the example described.

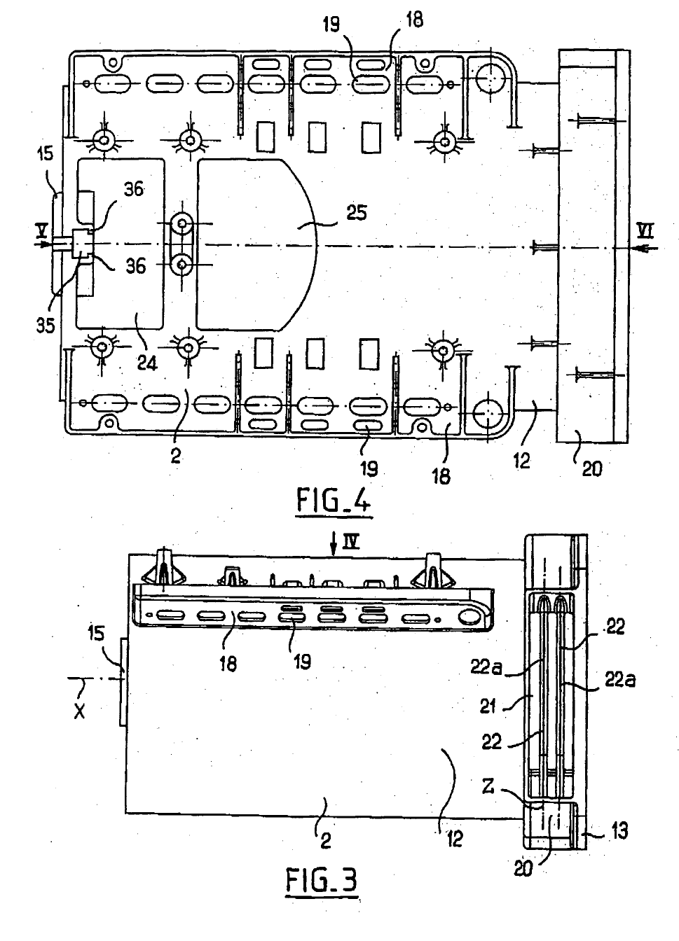

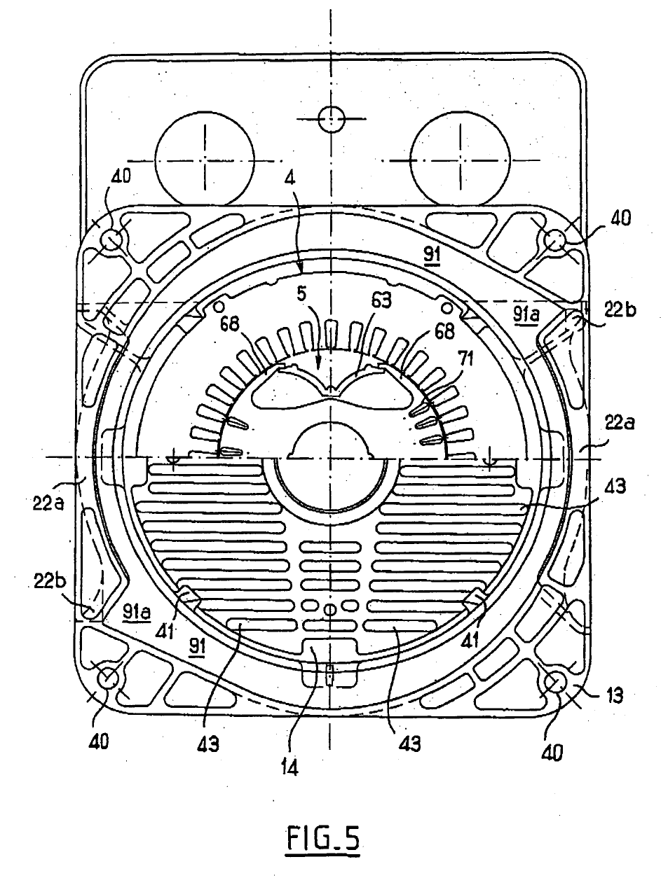

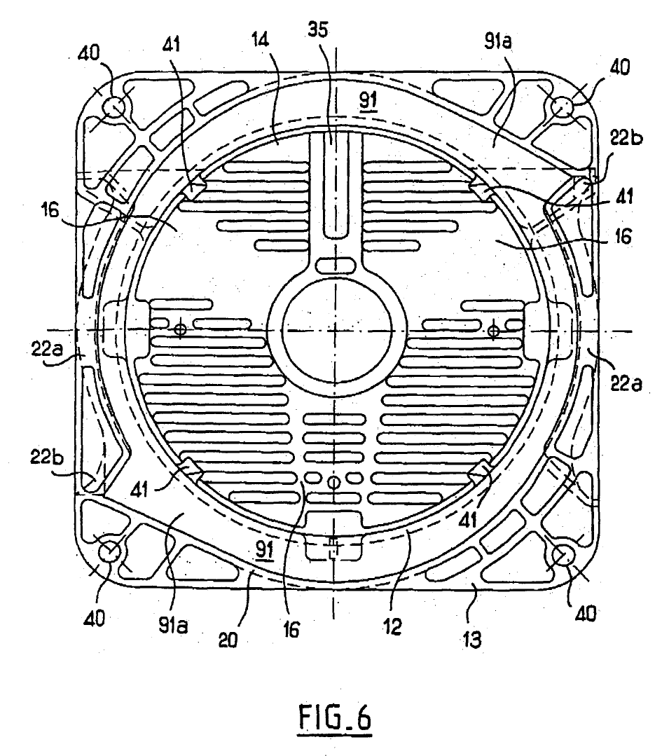

In FIGS. 1 and 3 it can be seen in particular that the casing 2 has two side extensions 18 in its upper portion extending over the major part of the cylindrical body 12, with the cover 3 resting thereon, each of said extensions 18 being provided with a plurality of openings 19 allowing air to enter beneath the cover, as explained in greater detail below.

The enlarged portion 20 which is made integrally with the remainder of the casing defines a housing for the fan 9.

Two side openings 21 are made in the enlarged portion 20 to allow cooling air to escape. Only one of these openings can be seen in FIGS. 1 and 3. Protective bars 22 are present in each of the openings 21 to protect people against making contact with the fan in operation. The bars 22 are made integrally with the casing 2, by casting. Prior to machining, the bars 22 are connected together on the inside by a web of cast material.

After being cast and fixed on the stator, the casing 2 is subjected to machining, in particular for the purpose of making a circularly cylindrical surface about the axis X inside the bearing 15 so as to receive a cage 11 containing ball bearings for supporting the rotor shaft.

The radially inner sides of the bars 22 are machined to remove the above-mentioned web. This machining is performed in a single pass so as to avoid a second pass which might damage the bars 22.

In FIG. 5, there can be seen splines 41 projecting from the radially inner surface of the cylindrical body 12 for fixing the stator. The splines 41 are made by casting and they are made with sufficient precision to avoid any need to machine them.

The transverse wall 14 has perforations 43 to allow cooling air to enter into the casing.

Air Outlet Grids

Each bar 22 presents a longitudinal axis Z which extends, as can be seen in particular in FIG. 3, parallel to a plane perpendicular to the axis of rotation X of the rotor, i.e. substantially vertically in the example described. The axis Z is not rectilinear, each bar 22 having a curvilinear central portion 22a with an inside that is concave towards the axis X.

On examining FIG. 3, it can also be seen that the bars 22 are connected at their longitudinal ends to the remainder of the casing 2 and that between their longitudinal ends they do not have any connection between one another all along their length. The grids formed by the bars 22 in the example described thus have no horizontal bars. This disposition serves to reduce head losses in the air flow passing through the openings 21 and thus to improve the effectiveness of ventilation.

In FIG. 5, it can be seen that the enlarged portion 20 defines two passages 91 forming a volute. In the example described, these two passages 91 are substantially images of each other in axial symmetry about the axis X.

Each passage 91 presents a flow section for passing air which increases on coming closer to the outlet.

In FIG. 5, the fan turns clockwise.

Each passage 91 has an enlarged portion 91a adjacent to a portion 22b of the bars 22. This portion 22b is connected at one end to the casing 2 and at the other end to the corresponding central portion 22a and co-operates therewith to form a concave shape facing outwards. This makes it possible to have the connection portion 22b directed substantially perpendicularly to the air flow direction.

There are two bars 22 per side opening 21 in the example described, however this number could naturally be different.

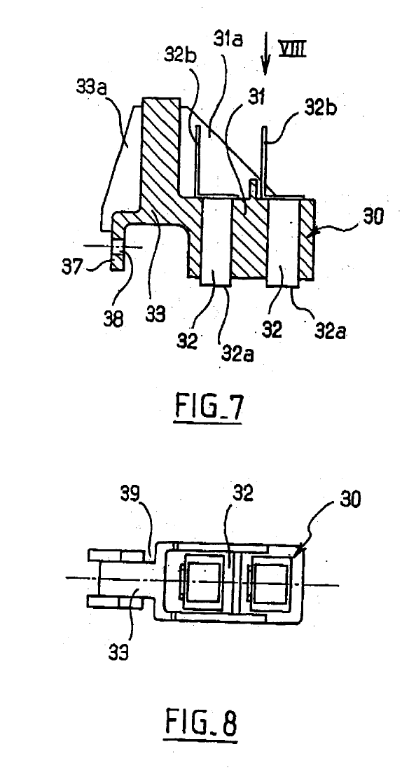

In its upper portion, the casing 2 has a first opening 24 as can be seen in FIG. 4, said opening serving to enable a brush carrier 30 (as shown diagrammatically in FIGS. 7 and 8) to be fixed inside the casing.

The casing 2 also includes, in its upper portion, a second opening 25 for co-operating with the opening 24 to allow cooling air to flow and to pass the electrical conductors of the stator.

Brush Carrier

In FIGS. 7 and 8, it can be seen that the brush carrier 30 comprises firstly a support portion 31 having conventional brushes 32 fixed thereon, for coming into contact via one end 32a with rotor slip rings 110, and secondly a fixing portion 33 for engaging in a slideway 35 formed in the inside face of the transverse wall 14 of the casing 2, the slideways 35 being vertical in the example shown. The brushes 32 are connected to connection tabs 32b for electrical conductors (not shown) for powering the rotor.

A groove 39 is formed between the support portion 31 and the fixing portion 33 to co-operate with rims 36 on the slideway 35.

The fixing portion 33 has an extension 37 provided with a hole 38 for passing a lock screw that is engaged in the transverse wall 14.

The brush carrier includes stiffening webs 31a and 33a associated respectively with the support portion 31 and with the fixing portion 33 and which extends substantially parallel to a plane containing the axis of rotation X and coinciding with the section plane of FIG. 2.

The support and fixing portions 31 and 33 in the example described are made as a one-piece molding of insulating plastics material.

The brush carrier 30 is fixed to the casing 2 by being initially inserted through the first opening 24 into the casing 11, and then causing the fixing portion 33 to slide in the slideway 35, after which the brush carrier 30 is prevented from moving axially along the slideway 35 by inserting a screw into the hole 38 and causing it to co-operate with the transverse wall 14.

Rotor

The yoke 7 of the rotor 5 is laminated in the example described and comprises a stack of magnetic laminations 60 each having slots 61 in which the wires of windings 8 are engaged. The yoke 7 need not be laminated.

In the example described, the rotor 5 is of the projecting pole type.

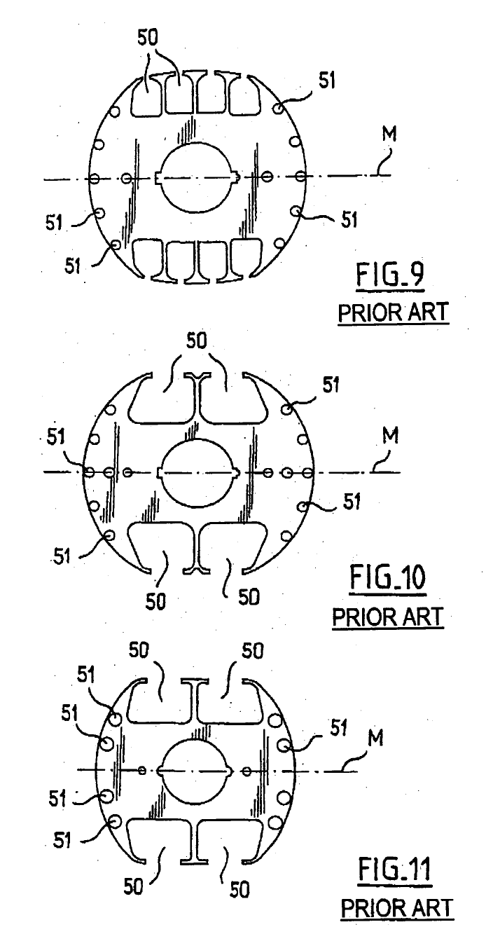

FIGS. 9 to 11 show various shapes of rotor lamination that are to be found in prior art alternators, for a rotor having two pole portions. In these examples, each lamination has slots 50 for receiving the field windings and passages 51 for damper windings for attenuating the generation of harmonics.

It can be seen that the slots 50 are disposed symmetrically on either side of a midplane M containing the axis of rotation, and that each lamination can have, for example, eight slots as shown in FIG. 9, or four slots as shown in FIGS. 10 and 11.

It can also be seen that the passages 51 for the damper windings are circular in prior art alternators and disposed close to the radially outer edges of the pole portions in a manner that is symmetrical about the midplane M.

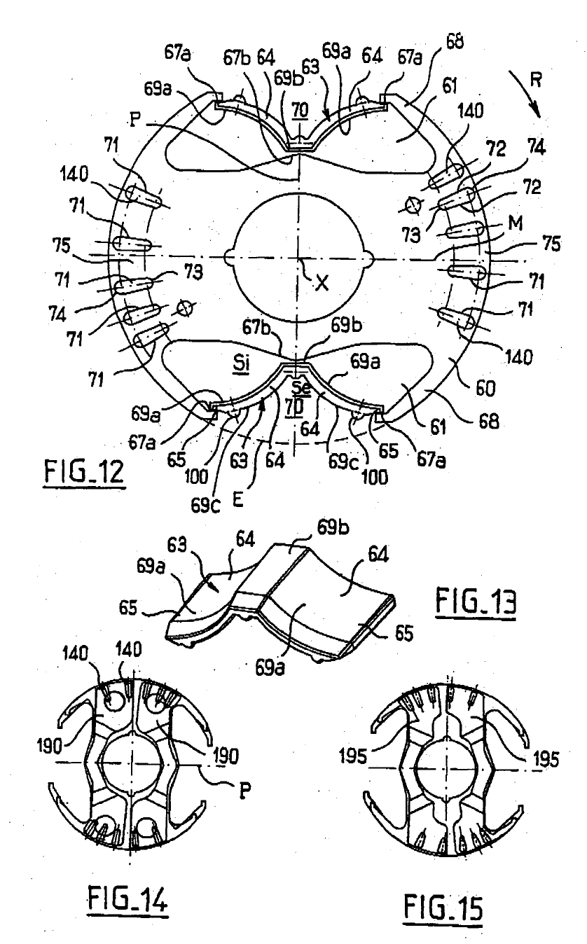

In the embodiment described, each magnetic lamination 60 is of the shape shown in FIG. 12 and presents axial symmetry about the axis X.

The slots 61 are disposed symmetrically on either side of a midplane M containing the axis X for receiving the field windings 8 (not shown in FIG. 12), which windings may be electrically connected to the slip ring 110 as in the example shown, with the above-described brushes 32 coming to bear against the slip rings.

Each lamination 60 defines two opposite pole portions 75, each of which is provided with two pole horns 68.

Spacers for Holding the Field Windings

The windings are held in the slots 61 by spacers 63, one of which is shown in isolation in a perspective view in FIG. 13.

In the example described, each spacer 63 is made of insulating plastics material and presents, in a plane perpendicular to the axis X, a V-shape with two wings 64. The free end 65 of each wing 64 bears against the inside edge 67a of a pole shoe 68 close to its free end.

It can be seen in the figures that each spacer 63 has two beads of material 100 projecting from the outside faces 69c of the wings 64 close to their free ends.

Each wing 64 presents a generally concave inside face 69a facing towards the corresponding pole portion 75.

The base of each spacer 63 bears or nearly bears against the stack of rotor laminations 60, possibly via an insulating sheet put into place in the slot 61 before the windings. A spacer 63 thus acts in a slot 61 to define two regions, and these regions receive windings associated respectively with the two pole portions 75. The base of the spacer 63 presents a generally flat face 69b which takes up a position facing an edge 67b of the slot 61, said edge 67b being generally outwardly convex. In FIG. 12, it can be seen that given the shape of the edge 67b, the section offered for passing magnetic flux does not pass through a minimum in the plane P containing the axis X and perpendicular to the midplane M.

Given their shape, the two wings 64 of each spacer 63 leave between them and the stator a space 70 of non-negligible section which allows increased air flow between the rotor and the stator. This makes it easier to cool the rotor.

In the example described, the section Sₑ defined by the circularly cylindrical envelope E of the rotor touching the pole shoes 68 and the spacer 63 is about one-fourth greater than the section Sᵢ of the slot on the inside of the spacer 63. A plurality of spacers 63 following one another along the axis X may be associated with each slot 61.

Disposition of the Damper Windings

Each lamination 60 has passages 71 for the damper windings.

In the example shown, these passages 71 are non-circular in shape.

More precisely, in the example shown, each passage 71 presents a cross-section that is oblong in shape, as can be seen in FIG. 12, having its long dimension oriented radially, with two long sides 72 that diverge radially outwards, these sides 72 being united at their axial ends by semicircular edges 73 and 74. The semicircular edge 74 has a tip close to the radially outer edge of the associated pole portion 75. When compared with a passage of circular section, the shape of the passages 71 and the radial orientation thereof facilitates the flow of magnetic flux from one pole portion 75 to the other.

In FIG. 12, it may be observed that on either side of the plane P, the space between the passages 71 is not regular. More particularly, in the example described, the spacing between the passages 71 increases on moving circumferentially in the clockwise direction about the axis X. In FIG. 12, the direction of rotation R of the rotor is clockwise, the rotor being seen from the end remote from its end fixed to the engine. This disposition of the passages 71 serves to attenuate harmonics more effectively. The spacing between the passages 71 is, in particular, different from the pitch of the teeth of the stator, and where the spacing is greater it makes it easier for flux to pass. The operation of the alternator under load is improved thereby.

The spacing between the passages 71 can be determined by a finite element calculation, for example so that the flux passing between the passages 71 does not exceed a predetermined value.

In the example described, the passages 71 are five in number on each side of the plane P. The passages 71 disposed on one side of the plane P in each lamination 60 constitute an image of the passages situated on the other side of the plane P, in axial symmetry about the axis X.

The damper windings may be made by injecting a conductive metal, e.g. aluminum, while under pressure and in the fluid state into the passages 71 of the stack of laminations 60 so as to form electrically-conductive bars 140. The laminations 60 are superposed with a small amount of angular offset between one another such that each of the bars 140 follows a path in the form of a portion of a helix, in conventional manner.

The bars 140 associated with each pole portion 75 are electrically interconnected at each axial end of the rotor by electrical short circuiting connection strips 190 and 195, also referred to as short-circuit “rings”.

FIG. 14 shows the connection strips 190 at the same end as the bearing 15 and FIG. 15 shows the connection strips 195 at the same end as the fan 9.

In these figures, it can be seen that each strip 190 or 195 electrically interconnects two bars 140 situated on one side of the midplane P with three bars 140 situated on the opposite side of said plane P.

For each end face, the two strips 190 or 195 are thus disconnected from each other and are of a shape that enables them to go round the shaft of the rotor.

Fixing the Alternator to the Engine

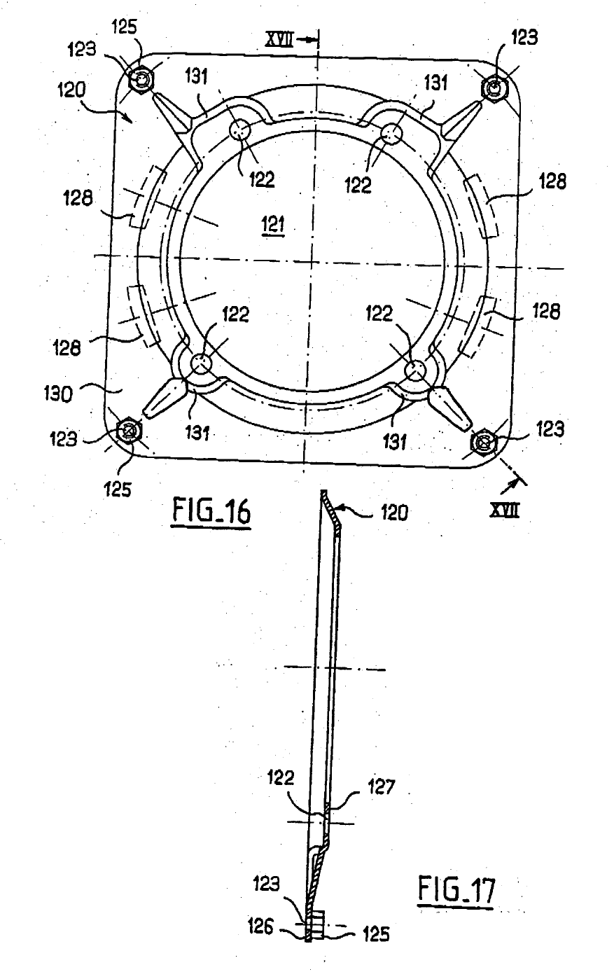

In the example described, the alternator is fixed to the engine by means of a connection member 120 which is shown on its own in FIGS. 16 and 17.

This connection member 120 comprises a plate 130 pierced by a central opening 121 for passing the end of the rotor shaft that is to be coupled with the engine shaft.

The plate 130 has a first set of holes 122 designed to enable it to be fixed to the engine, and a second set of holes 123 for fixing to the flange 13 of the alternator. In the example shown, nuts 125 are welded to the plate 120 in register with respective holes 123 on the side that is to face the engine.

FIG. 17 shows that the plate 120 is not plane, and that it may include stiffening ribs 131. The plate 120 presents a first plane surface 126 in the vicinity of its outer periphery, for coming to bear against the flange 13 of the casing 2, and a second plane surface 127 around the opening 121 for bearing against the engine. The two surfaces 126 and 127 are axially offset by a distance which is greater than the thickness of the nuts 125.

Projecting portions 128 are designed to co-operate with the casing, for example by being welded to the plate 130, so as to contribute to centering the connection member on the alternator.

In order to fix the alternator to the engine, the plate 130 is initially fixed thereto by inserting fasteners such as screws in the holes 122, and then the alternator can be fixed to the plate 130 by inserting fasteners such as screws into the passages 40 and the holes 123.

It should be observed that by placing the passages 40 outside the envelope of the cylindrical body 12, it is very easy to insert the fasteners for holding the alternator casing to the connection member 120. The fasteners may be tightened, e.g. by means of a wrench, without it being necessary to insert the wrench through an outlet opening for cooling air, as is the case in prior art alternators.

Naturally, the invention is not limited to the embodiment described above.

In particular, without going beyond the ambit of the present invention, it is possible to make casing differently.

Throughout the description, including in the claims, the term “comprising a” should be understood as being synonymous with “comprising at least one” unless specified to the contrary.

What is claimed is:

1/ An electric rotary machine comprising:
a casing of elongate shape;
a rotor having a shaft capable of turning inside the casing about an axis of rotation; and
a fan rotated by the rotor;
wherein the casing includes at least one air inlet grid and at least one air outlet grid, both of which are made integrally with the casing.

2/ A machine .according to claim 1, wherein the casing is made as a casting.

3/ A machine according to claim 2, wherein the casing is made out of injected aluminum.

4/ A machine according to claim 2, wherein the casing has a flange at a first longitudinal end, and has a perforated end wall at a second longitudinal end opposite from the first, the end wall being made integrally with the casing and forming the air inlet grid.

5/ A machine according to claim 4, wherein the flange is made integrally with the casing.

6/ A machine according to claim 4, wherein the end wall includes a portion in relief on an inside face serving to fix a brush carrier.

7/ A machine according to claim 6, wherein the portion in relief comprises a slideway, and wherein the brush carrier is configured to be capable of sliding in the slideway while being mounted in the casing.

8/ A machine according to claim 1, wherein the casing has two side grids made integrally with the casing and situated respectively on the left and right sides of the casing when the alternator is observed along the axis of rotation of the rotor.

9/ A machine according to claim 1, wherein the casing includes at least one volute opening out to a grid.

10/ A machine according to claim 1, wherein the casing has at least one grid including bars, each having a longitudinal axis extending substantially parallel to a plane perpendicular to the axis of rotation of the rotor.

11/ A machine according to claim 10, wherein the bars present a radially inner side that is machined.

12/ A machine according to claim 1, wherein the casing includes extensions for supporting a cover, said extensions including air inlet openings, the casing having at least one opening opening out to the inside of the cover to enable air to be sucked in beneath it when the alternator is in operation.

13/ A machine according to claim 1, wherein the casing includes non-machined axial splines against which a stator rests.

14/ A machine according to claim 1, wherein the casing comprises a cylindrical body and a flange, the flange having passages for fixing elements having axes situated radially outside the envelope of the cylindrical body.

15/ A machine according to claim 1, constituting an alternator.
